(19) United States
(12) Patent Application Publication
(10) Pub. No.: US 2006/0293949 A1
(43) Pub. Date: Dec. 28, 2006

(54) Method and apparatus for generating targeted advertisements

(76) Inventors: Joshua Grossnickle, San Francisco, CA (US); Eric Rodriguez, San Mateo, CA (US); Leslie Smith, Campbell, CA (US)

Correspondence Address: BRINKS HOFER GILSON & LIONE, P.O. BOX 10395, CHICAGO, IL, 60610, US

(21) Appl. No.: 11/159,456

(22) Filed: Jun. 23, 2005

(51) Int. Cl. G06Q 30/00

(52) U.S. Cl. 705/14

(57) ABSTRACT

Methods and systems for generating personalized advertisements or greetings to specified users are disclosed. Existing advertisement methods do not allow advertisers to adequately target specific recipients, and the costs associated with typical Internet advertising, such as developing the advertisement content and purchasing advertisement space, can be prohibitive to smaller businesses and users. The methods and systems described herein solve these problems by allowing advertisers to customize advertisement templates and specify individual recipients for the customized advertisement, and deliver the customized advertisement to the specified recipients.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. The following notice applies to any software and data as described below and in the drawings hereto: Copyright © 2005, Yahoo, Inc. All Rights Reserved.

### BACKGROUND

The transfer of information over computer networks has become an increasingly important means by which institutions, corporations, and individuals do business. Computer networks have grown over the years from independent and isolated entities established to serve the needs of a single group into vast internets which interconnect disparate physical networks and allow them to function as a coordinated system. Currently, the largest computer network in existence is the Internet. The Internet is a worldwide interconnection of computer networks that communicate using a common protocol. Millions of computers, from low end personal computers to high end supercomputers, are connected to the Internet.

The Internet has emerged as a large community of electronically connected users located around the world who readily and regularly exchange vast amounts of information. The Internet continues to serve its original purposes of providing for access to and exchange of information among government agencies, laboratories, and universities for research and education. In addition, the Internet has evolved to serve a variety of interests and forums that extend beyond its original goals. In particular, the Internet is rapidly transforming into a global electronic marketplace of goods and services as well as of ideas and information.

This transformation of the Internet into a global marketplace was driven in large part by the introduction of common protocols such as HTTP (HyperText Transfer Protocol) and TCP/IP (Transmission Control Protocol/Internet Protocol) for facilitating the easy publishing and exchange of information. The Internet is thus a unique distributed database designed to give wide access to a large universe of documents published from an unlimited number of users and sources. The database records of the Internet are in the form of documents known as “pages” or collections of pages known as “sites.” Pages and sites reside on servers and are accessible via the common protocols. The Internet is therefore a vast database of information dispersed across seemingly countless individual computer systems that is constantly changing and has no centralized organization.

Computers connected to the Internet may access pages via a program known as a browser, which has a powerful, simple-to-learn user interface, typically graphical and enables every computer connected to the Internet to be both a publisher and consumer of information. Another powerful technique enabled by browsers are known as hyperlinking, which permits page authors to create links to other pages that users can then retrieve by using simple commands, for example pointing and clicking within the browser. Thus each page exists within a nexus of semantically related pages because each page can be both a target and a source for hyperlinking, and this connectivity can be captured to some extent by mapping and comparing how those hyperlinks interrelate. In addition, the pages may be constructed in any one of a variety of syntaxes, such as Hyper Text Markup Language (HTML) or eXstensible Markup Language (XML), and may include multimedia information content such as graphics, audio, and still and moving pictures.

Because any person with a computer and a connection to the Internet may publish their own page on the Internet as well as access any other publicly available page, the Internet enables a many-to-many model of information production and consumption that is not possible or practical in the offline world. Effective search services, including search engines, are an important part of the many-to-many model, enabling information consumers to rapidly and reliably identify relevant pages among a mass of irrelevant yet similar pages. Because of the many-to-many model, a presence on the Internet has the capability to introduce a worldwide base of consumers to businesses, individuals, and institutions seeking to advertise their products and services to consumers who are potential customers. Furthermore, the ever increasing sophistication in the design of pages, made possible by the exponential increase in data transmission rates, computer processing speeds and browser functionality makes the Internet an increasingly attractive medium for facilitating and conducting commercial transactions as well as advertising and enabling such transactions. Because the Internet allows direct identification of and connection between businesses and targeted consumers, it has the potential to be a powerfully effective advertising medium.

The availability of powerful new tools that facilitate the development and distribution of Internet content (this includes information of any kind, in any form or format) has led to a proliferation of information, products, and services offered through the Internet and a dramatic growth in the number and types of consumers using the Internet.

Thus, the Internet has emerged as an attractive new medium for advertisers of information, products and services (“advertisers”) to reach not only consumers in general, but also to enable increased capabilities to identify and target specific groups of consumers based on their preferences, characteristics or behaviors. However, the Internet is composed of an unlimited number of sites dispersed across millions of different computer systems all over the world, and so advertisers face the daunting task of locating and targeting the specific groups or subgroups of consumers who are potentially interested in their information, products and/or services. These efforts are well worth their reward; however, as a well placed advertisement on a high traffic website may produce as many views as conventional print or television advertising. Even more important than just placing an Internet advertisement is the ability to target consumers who will actually observe and appreciate the content. Advertisers get far more “bang for their buck” by targeting advertisements, and are therefore willing to pay more money for this type of ad placement.

A common way for advertisers to target particular users is to purchase advertising space on a particular site. For example, many sites sell advertising space for banner ads. Banner ads are graphical images that are used on Web sites to advertise information, products or services. Banner ads usually conform to a standard size (such as 460 pixels wide×60 pixels tall). The use of a standard size enables developers to design a site that allows for the interchangeability of ads and also allows advertisers to use the same banner ad repeatedly. Typically, banner ads are sold per “impression,” which is a particular instance of a banner. Unfortunately, traditional banner advertisement price structures are geared for advertisers seeking large audiences. In most cases, advertisers sell banner ad space per 1,000 impressions, leaving consumers and small business owners paying for needless impressions.

Current banner ads provide a limited way for advertisers to perform targeted marketing. For example, advertisers may be able to target specific users by choosing a site whose visitors' demographic information most closely match the advertisers targeted audience. Additionally, advertisersg may determine a user's interest in certain areas from a user's page views or self declared information, such as demographics. However, the methods do not provide a complete view of a user's interests and their likely responses to advertisements. Using pages a user views or user demographic information does not provide an accurate measure as to whether a user would actually click on an advertisement and actually buy a product from the advertiser after clicking on the advertisement. Moreover, demographic information provides no guarantee that specific users exhibiting those characteristics actually see an advertisement.

In sum, known methods used by advertisers to control their exposure and target their distribution, such as banner advertising, follow traditional advertising paradigms and fail to utilize the unique attributes of the Internet's one-to-one publishing model. Thus, the traditional paradigms relating to Internet advertising and search engines fail to effectively deliver relevant advertisements to interested parties in a timely and cost-effective manner.

Thus, advertising on the Internet needs to be focused in a new direction to facilitate an online marketplace which provides advertisers with a reliable, verifiable and cost-effective way to target both small and large audiences of consumers and position the advertisers' products and services.

### BRIEF SUMMARY

In one embodiment, a method for generating a personalized advertisement for a user is described. The method may include providing a plurality of creatives, receiving a first set of information indicative of at least one of the plurality of creatives, and receiving personalization information for customizing the at least one of the plurality of creatives. The method may also include generating a personalized advertisement including the first set of information and the personalization information, receiving scheduling information for the personalized advertisement, the scheduling information including a plurality of specified recipients, and submitting the personalized advertisement and the scheduling information to an advertisement tool.

In another embodiment, a system for delivering personalized advertisements to a plurality of recipients is described. The system may include a web site including a plurality of web pages including advertisements, and an advertisement personalization module in communication with the web site. The advertisement personalization module may be operable to customize an advertising template in response to user input, receive advertisement scheduling information and a plurality of specified recipients, each specified recipient being a registered user of the web site, and submit the customized advertisement template, scheduling information, and specified recipients to an ad server. Additionally, the web site may deliver the customized advertisement template to the plurality of specified recipients as part of the web page advertisements in accordance with the scheduling information.

In another embodiment, a method for delivering a personalized greeting to a recipient is described. The method may include providing a plurality of greeting templates, each greeting template comprising a banner, receiving a first set of information indicative of a selection of at least one of the plurality of greeting templates, receiving personalization information for customizing the selected greeting template, generating a personalized greeting including the selected greeting template and the personalization information. The method may also include receiving scheduling information for the personalized greeting, the scheduling information including a plurality of specified recipients, and delivering the personalized greeting to the recipient as an advertisement on a web page in accordance with the scheduling information.

These and other embodiments and aspects of the invention are described with reference to the noted Figures and the below detailed description of the preferred embodiments.

### BRIEF DESCRIPTION OF THE DRAWINGS

FIG. 1 is a diagram of an exemplary system for creating and delivering target advertisements;

FIG. 2 is a flow chart of an exemplary method for creating and delivering targeted advertisements;

FIG. 3 is an exemplary screen shot for selecting a creative in accordance with one embodiment of the present invention;

FIG. 4 is another exemplary screen shot for selecting a creative in accordance with one embodiment of the present invention;

FIG. 5 is an exemplary screen shot for personalizing a creative in accordance with one embodiment of the present invention;

FIG. 6 is an exemplary screen shot for selecting recipients for an advertisement in accordance with one embodiment of the present invention;

FIG. 7 is an exemplary screen shot for selecting a launch date for an advertisement in accordance with one embodiment of the present invention;

FIG. 8 another exemplary screen shot for personalizing an advertisement in accordance with one embodiment of the present invention;

FIG. 9 is an exemplary screen shot for submitting a targeted advertisement to an ad server in accordance with one embodiment of the present invention;

FIG. 10 is an exemplary screen shot of the Yahoo! web portal;

FIG. 11 is an exemplary screen shot of a targeted advertisement being delivered through the Yahoo! web portal; and

FIG. 12 is an exemplary screen shot of a landing page for a targeted advertisement in accordance with one embodiment of the present invention.

### DETAILED DESCRIPTION

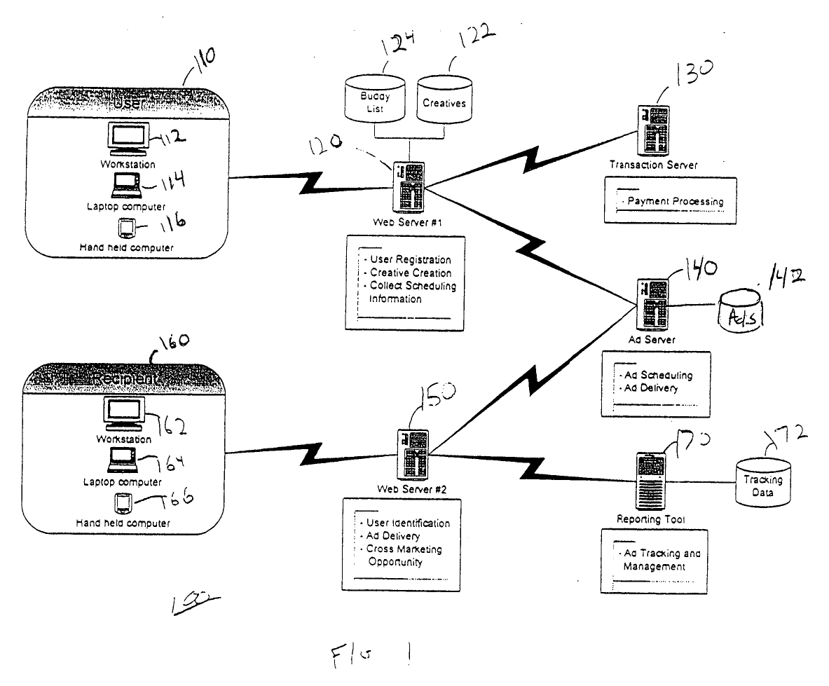

Referring to the drawings, and initially to FIG. 1, an exemplary system for creating and delivering personalized advertisements is shown. The system may include an ad creation server 120, a transaction server 130, an ad server 140, a web server 150, and a reporting tool 170. Although reference will now be made to specific components of the system performing specific features, it should be apparent to one of ordinary skill in the art that such reference is exemplary, is not intended to limit the scope of the claims in any way, and that the functionalities described herein may be implemented in a virtually unlimited number of configurations. For example, a single server may be configured to provide all of the system's functionalities.

The system 100 may deliver personalized advertisements as the result of an advertisement being created and that advertisement being delivered to its recipients. Advertisement creation entails the steps required to create an advertisement and may include such processes as selecting an advertisement creative or template, adding personalization information, specifying recipients, specifying ad scheduling information, and the like. As used herein, the term “creative” includes any aspect of the content of an advertisement. Creatives may include graphics, audio, code segments and the like used as part of an advertisement. For example, creatives may include HTML, DHTML, or JAVA code segments to provide enhanced functionalities. Creatives may comprise DHTML banner ads. The systems and methods disclosed herein are not limited in the types of creatives that may be used. It should also be noted that creatives need not be commercial in nature. For example, creatives may include advertisements, announcements, invitations and the like. The advertisement may then be delivered to the specified recipients in any known manner. The advertisements may include banner ads that may be delivered as part of a web portal, such as the Yahoo! web portal, a portal visited daily by hundreds of thousands, if not millions, of users. It should be apparent to one of ordinary skill in the art that the advertisement creation process is limited only by the manner in which advertisements may be delivered, and that such delivery options may vary from implementation to implementation with departing from the spirit and scope of the claimed invention.

In order to create an advertisement, an advertiser 110 may connect to the ad creation server 120 via a communication network 118. The communication network 118 may be any private or public communication network. Preferably, the advertiser 110 may connect to the ad creation server 120 via the Internet using a standard browser application. A browser based implementation allows system features to be accessible regardless of the advertiser's 110 underlying platform. For example, the advertiser 110 may connect via a workstation computer 112, laptop computer 114, or handheld computer 116 which may all utilize different hardware and/or software packages. The ad creation server 120 may be a web server that delivers Web pages to browsers and other files to applications via the HTTP protocol. Alternatively, or additionally, the advertiser 110 may connect to the ad creation server 120 using a stand-alone application which may be either platform dependent or platform independent.

Once connected, the advertiser 110 may access a variety of features provided by the ad creation sever 120. The ad creation server 120 may provide services that allow an advertiser to log in and/or register for the system 100, create, select, and/or customize an advertisement creative, specify recipients for the advertisement, and schedule the advertisement. Users may be required to log in to the system in order to access system features. User information, such as a user name, password, demographic information, and the like, may be exclusive to the ad creation and delivery system 100 or may be leveraged with other systems. For example, the ad creation and delivery system 100 may be provided as part of the Yahoo! portal. Users of the Yahoo! portal may access any of the features of the system 100. Similarly, advertisers 110 may be required to sign up for a Yahoo! user name before accessing the system 100. Alternatively, or additionally, the system 100 may leverage log in information from multiple existing systems. Alternatively, no log in information is required to access the system 100.

Once the advertiser 110 specifies a creative, customization and/or scheduling information for the advertisement, the ad creation server 120 may optionally communicate with the transaction server 130 to collect any applicable fees associated with the advertisement. The ad creation server 120 may generate an order based on the selection. The order may include any calculated costs associated with the selected creative and scheduling information, described in more detail below. Once an order is created, the ad server 120 may pass the order to the transaction server 130, which may process the order such as by known methods. Alternatively, the ad server 120 may collect fees without the use of a transaction server 130. Alternatively, all advertisements may be free, obviating the need for the transaction server 130.

After an advertisement has been created, and any appropriate fees collected, the advertisement may be submitted to an ad server 140. The ad server may be responsible for maintaining a database of advertisements 142 and delivering the advertisements to the specified recipients 160 in accordance with various scheduling parameters. For example, the advertisements may be delivered in accordance with the advertiser-specified delivery options. The ad server 140 may be responsible only for delivering the targeted advertisements of the system 100, or may be responsible for delivering additional advertisements as well.

The ad server 160 also may be in communication with one or more additional servers 150 through which ads may be delivered to recipients 160. For example, a web server 150 associated with the Yahoo! portal may be in communication with the ad server 140 and operable to receive ads from the ad server 140 and transmit the ads to recipients 160 for display on a standard browser application. As described above, the use of a standard browser for displaying ads allows system features to be accessible regardless of the recipient's 160 underlying platform. For example, the recipient 160 may connect via a workstation computer 162, laptop computer 164, or handheld computer 166 which may all utilize different hardware and/or software packages. Ads, including personalized ads or greetings, targeted or directed ads, and the like, may be delivered as recipients 160 log in to the system 100. Alternatively, or additionally, ads may be delivered as recipients 160 access features associated with the personalized ads. For example, personalized ads, such as birthday greetings, may be delivered when recipients 160 access email features of the Yahoo! Portal. After receiving this greeting, the recipients 160 may receive target ads related to birthday gifts, party supplies, and the like. By leveraging the type of personalized ad being delivered to a target audience, highly effective targeted cross-marketing and other marketing materials can be delivered to recipients when they need those products or services.

Optionally, a reporting tool 170 may be in communication with the additional servers 150. The reporting tool 170 may track various advertising related data and provide advertisement management services. The reporting tool may track the number of times each recipient views the advertisement. Alternatively, or additionally, the reporting tool 170 may track additional advertising data, such as recipient demographic data, click-through information, and the like.

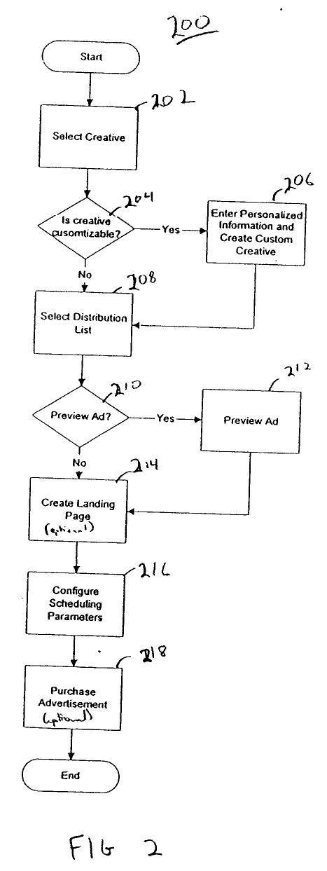

Referring to FIG. 2, a chart depicting an exemplary ad creation and delivery process is shown. In order to create a personalized ad, the advertiser may initially select a advertisement creative at step 202.

The user may select from a plurality of defined creatives. Alternatively, or additionally, users may be allowed to provide their own creatives. For example, the system 100 may allow users to upload user-generated images, audio, and the like. User uploaded advertisements may only conform to general guidelines, such as advertisement size. Alternatively, user uploaded advertisements may be reviewed by quality control personnel before being delivered to recipients 160. The review may ensure that questionable content is not delivered.

The advertiser 110 may select a single creative. Alternatively, the user may select multiple creatives that may be delivered to recipients 160 in a variety of ways. For example, each recipient 160 may receive each creative in a particular order as specified by the advertiser 110. Alternatively, the ad server 140 may be configured to arbitrarily select one of the multiple creatives at delivery time, delivering a different ad each time a specific recipient 160 accesses the system. The use of multiple creatives allows advertisers 110 to create advertising campaigns that ensure each ad is leveraged to its maximum extent on a per-recipient basis.

Creatives may be free to an advertiser, or a fee may be associated with the creative. For example, designer lines of creatives, or premium creatives, may be provided where each creative includes an associated fee. Both free and premium creatives may be provided simultaneously or alternately.

After a creative is selected, the system may determine if the creative can be customized at step 204. If so, the creative may a customized at step 206. Any part of the creative may be customizable, such that the user may customize the appearance or behavior of a creative. Alternatively, or additionally, the content of a creative may be static to ensure quality control. Preferably, a plurality of creatives with limited customizable options may be provided as a compromise between quality control and user flexibility. For example, the user may be able to customize certain attributes of a creative, such as font face, size and color information. Advertisers may add text to a creative. For example, an advertiser making a birthday announcement may enter information such as name, sex, and age information. Additionally, advertisers 110 may also edit audio associated with the advertisement. For example, an advertiser 110 may upload MIDI files to be played with the advertisement. After the personalization information has been supplied, the creative may be updated with the information.

Next, recipients 160 are selected at step 208. Advertisers 110 may select any registered user of the system. Recipients may be chosen based on a user name, ID or other identifier. For example, an advertiser 110 may select any registered member of a portal. Additionally, the system 100 may allow recipients to be selected from multiple systems, such as the Yahoo! portal and the Yahoo! 360° network.

Limits may also be placed on the pool of users that an advertiser 1 10 may designate as a recipient 160. For example, only users having a permissive advertising relationship with as the advertiser 1 10 may be recipients 160. For example, the Yahoo! portal offers messaging services among its members in which “buddy lists” help users manage their online contacts. In the Yahoo! system, users must consent to receive messages from the other member before that user may be added to the other member's “buddy list.” Accordingly, optionally only members of an advertiser's 110 “buddy list” may be designated as a recipient 160.

Alternatively, or additionally, recipients 160 may specify various levels of permissions. Using this approach, a sliding scale may be used to balance the intrusiveness of the advertisement with a level of permission a particular user has granted. For example, recipients may be able select from a variety of permission settings, such as “visual advertisements only” or “visual and auditory advertisements”. Additional exemplary preferences may include animation preferences that denote a preference for animated advertisements or bandwidth preferences that specify size limits of incoming advertisements. In other systems, users may not have to consent to receive messages.

The advertiser may optionally preview the advertisement at step 210. For example, the selected creative may be updated with personalization information and delivered to the advertiser 110. The advertiser 110 may then review the advertisement and correct any deficiencies before scheduling the advertisement.

Other pages, such as a landing page, may be created at step 216. The landing page may be a web page or other page containing additional information about the advertisement. For example, a landing page may include additional details about an offer, cross marketing opportunities, the location of a party, etc. The landing page may be linked to the advertisement such that recipients may be redirected to the landing page by clicking on the advertisement. Additional services may also be accessible via the landing page. The landing page may include bulletin board features that allow recipients to discuss events associated with the advertisements. Alternatively, or additionally, RSVP services may also be provided via the landing page. The landing page may also include link that directs recipients 160 to the ad creation process. Each service provided as part of the landing page may be free, or a fee may be associated with each service or feature. For example, a landing page bulletin board feature may cost a dollar amount such as $5. Other dollar amounts may be charged.

An advertiser-specific landing page may provided. The advertiser-specific landing page may be accessible only by the advertiser 110, while recipients are directed to a standard landing page. The advertiser-specific landing page may include information about which recipients have clicked-through an add. The advertiser-specific may populated with information from the reporting tool 170. Alternatively, the advertiser-specific landing page may include information from other sources, such as the ad server 140. Any type of customer relationship management tools may be provided on the advertiser-specific landing page. Similar to the standard landing page, each service or feature included in the advertiser-specific landing page may be free or have an associated fee.

Next, the advertiser may configure scheduling parameters for the advertisement at step 216. Scheduling parameters may include a start date. Alternatively, or in addition to, advertisers 110 may specify a variety of scheduling parameters. For example, advertisers 1 10 may select an end date for the advertisement, number of impressions, number of impressions per recipient, and the like. Where advertisers 110 are allowed to select multiple advertisements, additional scheduling parameters may include a delivery order for the advertisements, start and end dates for each particular add, number of impressions for each particular ad, advertisement rotation information, and the like.

Each scheduling parameter may be associated with a fee. For example, 100 impressions may cost $5. Alternatively, a daily rate may be charged regardless of the number of impressions. Advertisers 110 may be charged per recipient, such as $1 per recipient. Each recipient may receive a fixed number of impressions of the advertisement. For example, each recipient may receive the advertisement 20 times. Alternatively, or additionally, the advertisement may be delivered to each recipient 160 for a specified time period, so that each recipient may receive the advertisement an unlimited number of times at a determined rate during the specified time period. Combinations of delivery techniques and fee structures are also contemplated herein. Ads may be delivered on a per recipient basis where each recipient may only receive a specified number of impressions during a specified time period. For example, advertisers 110 may specify that an advertisement should be delivered to 20 recipients such that each recipient may view the advertisement up to 3 times during a two-day time period. A number of delivery options may be implemented without departing from the spirit and scope of the invention. Such delivery options are not intended to limit the scope of the claims.

After the creative, personalization information, and landing page have been created and recipients and scheduling have been specified, the advertiser 110 may purchase the advertisement at step 218. Initially, fees associated with the advertisement are totaled. As described above, fees may be associated with the content of the creative as well as the selected recipients, landing page options, and scheduling parameters for the advertisement. An order include the totaled fees may be delivered to the advertiser 110. At this point, the advertiser 110 may review the order for accuracy. If the information is incorrect, the advertiser 1 10 may edit any of the specified parameters. Once the order is correct, the advertiser 110 may purchase the advertisement. The order may be submitted to a transaction server 130 which may process the order.

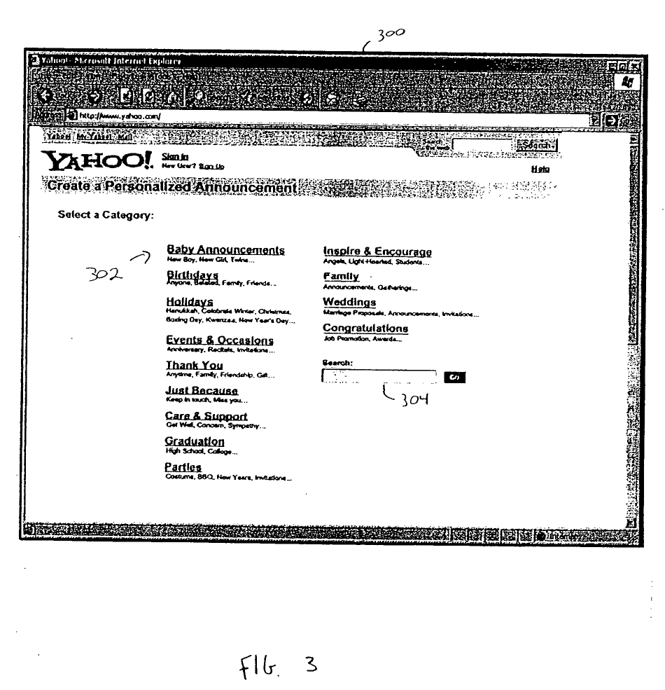

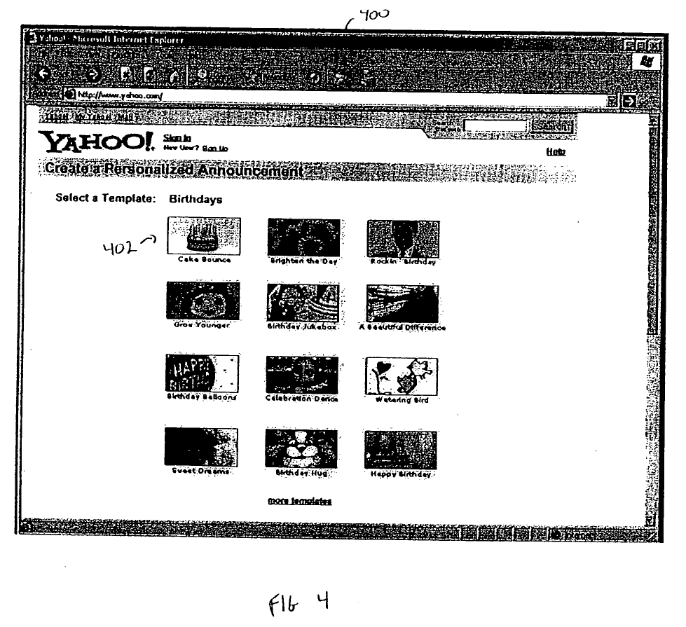

Referring now to FIGS. 3-12, exemplary screen shots of a personalized advertisement creation and delivery system are shown. In FIGS. 3-12, the personalized advertisement creation and delivery system is provided as part of the Yahoo! portal, and there are no fees associated with any of the personalized advertisement services. Initially, an advertiser 110 wishing to create a personalized advertisement may select a creative. As shown in FIG. 3, the advertiser 110 may be directed to a web page 300 for selecting a creative. As illustrated, creatives are organized hierarchically by category 302. Exemplary creative categories 302 may include baby announcements, birthdays, holidays, events and occasions, thank you, just because, care and support, graduation, parties, inspire and encourage, family, wedding, congratulations and the like. Optionally, the user may search for a particular creative by entering keywords 304. After selecting a creative category, the advertiser may be directed to one or more web pages 400 including available creatives 402 from the selected category, as shown in FIG. 4.

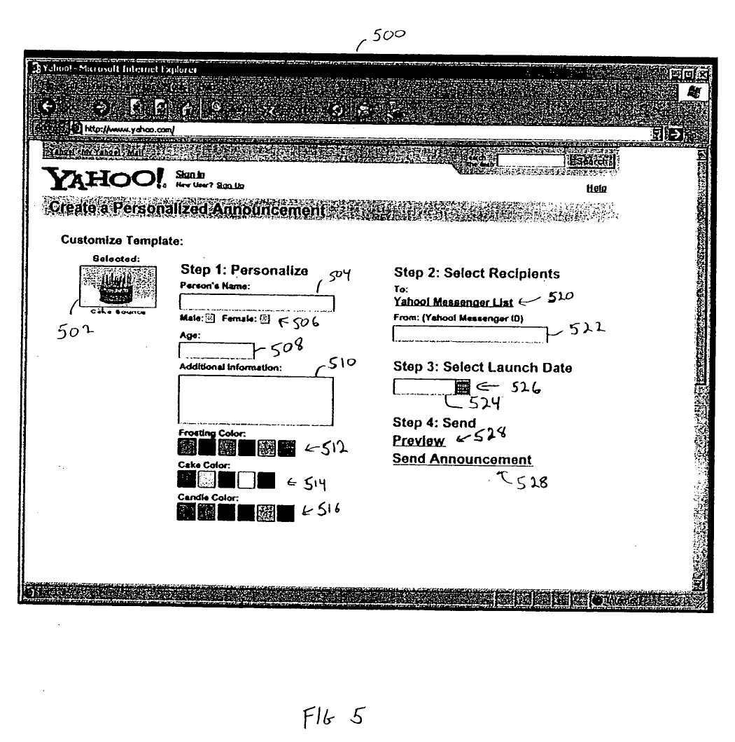

Once a creative has been selected, the advertiser 110 may next be directed to one or more web pages 500 which allows the advertiser to enter personalization information for the selected creative, select recipients and specify scheduling information, as shown in FIG. 5. As noted above, personalization information may be vary from creative to creative and may be dependent on the type of creative selected. In FIG. 5, for example, the advertiser has selected the “cake bounce” birthday creative. Accordingly, the advertiser may personalize the creative to include the person's name 502, sex 506, age 508, and additional information 510. Additionally, the advertiser may customize the appearance of the advertisement by selecting among various options, such as frosting color 512, cake color 514, and candle color 516. Optionally, an image 502 representative of the selected creative may also be displayed.

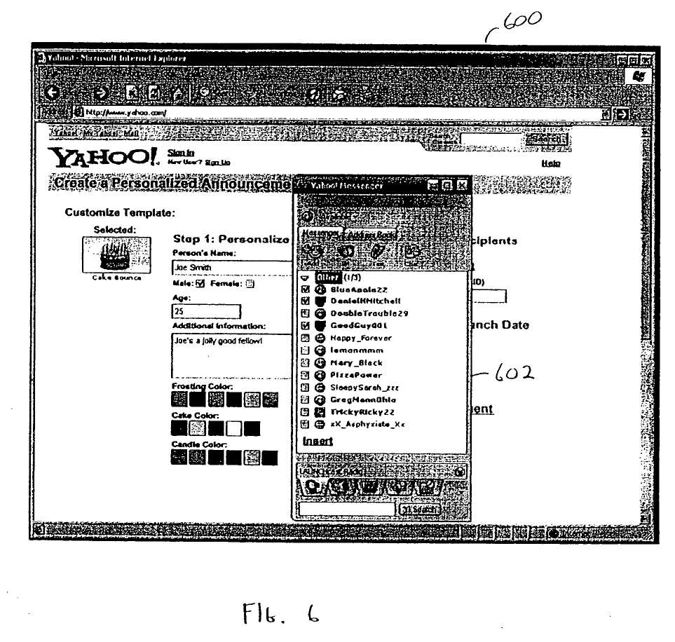

Next, the advertiser may select recipients by selecting the appropriate control 520. Advertisers may only select recipients 160 from the advertiser's Yahoo! Messenger “buddy list.” Alternatively, recipients may be specified via a variety of methods, such as selecting recipients from a Yahoo! 360° friends list, an address book, or database, entering an email address, instant messaging user ID, and the like. Activation of the select recipients control 520 may launch a Yahoo! Messenger dialogue 602 for selecting recipients, as shown in FIG. 6. The advertiser may then select recipients within the dialogue 602, and the information may be transmitted to the system 100. Alternatively, advertisers may be directed to an additional web page with appropriate controls to allow the advertiser to select recipients from their “buddy list.” A text list of recipients may then be generated based on the advertiser's selections.

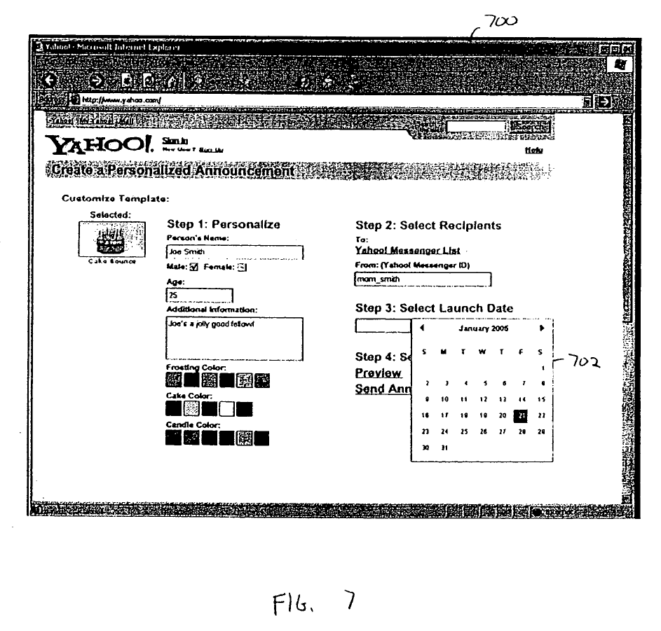

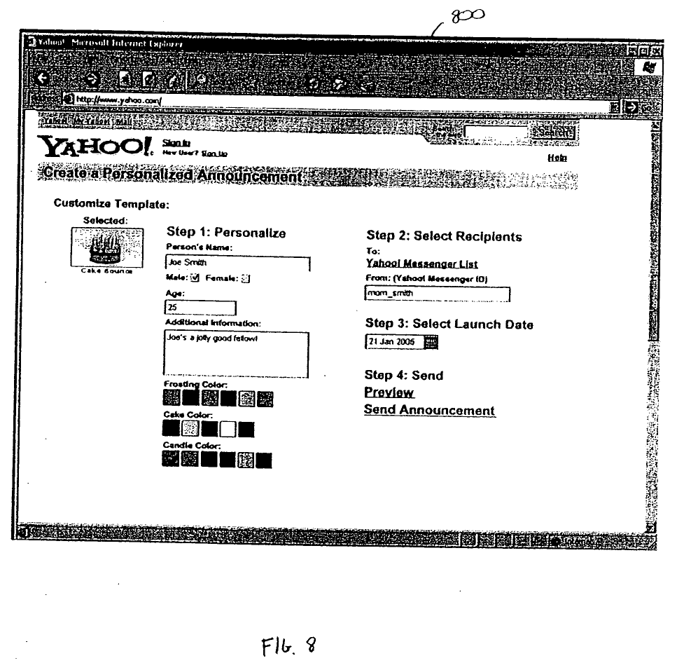

Referring again to FIG. 5, the advertiser 110 may also provide identification information 522. The identification information includes a Yahoo! identifier or user name. The advertiser 110 next may select a start date for the advertisement by entering a date 524. Optionally, the advertiser may select a date by activating the calendar icon 526. As shown in FIG. 7, activation of the calendar icon 524 may launch a date selection dialogue 702 that allows the user to select a start date for the advertisement. Optionally, the advertiser 110 may select to preview the add by selecting the appropriate control 528. In FIG. 8, a completed page 800 with personalization, customization, recipient, and start date information is shown.

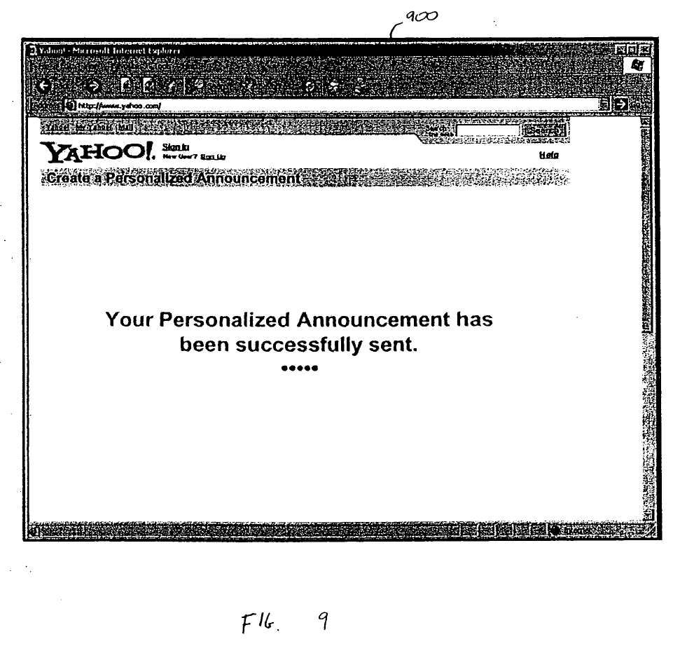

Referring again to FIG. 5, the user may purchase the advertisement and submit it to the ad server 140 for delivery by selecting the send announcement control 528. As illustrated, the system 100 may submit profiles, scheduling information, and the customized creative to a scheduling component of the ad server 140. For example, the system 100 may generate a UDS key for the list of recipients 160. The UDS key may be a custom list of the intended recipients. Profiles may then be generated for each recipient in the list. Each profile may include, for example, the UDS key to which the recipient belongs as well as additional information from the recipient's Yahoo! profile. Once the profiles have been created, the profiles, scheduling information and customized creative may be submitted to the scheduling component. As shown in FIG. 9, advertisers may be directed to a web page 900 indicating the successful submission of an advertisement.

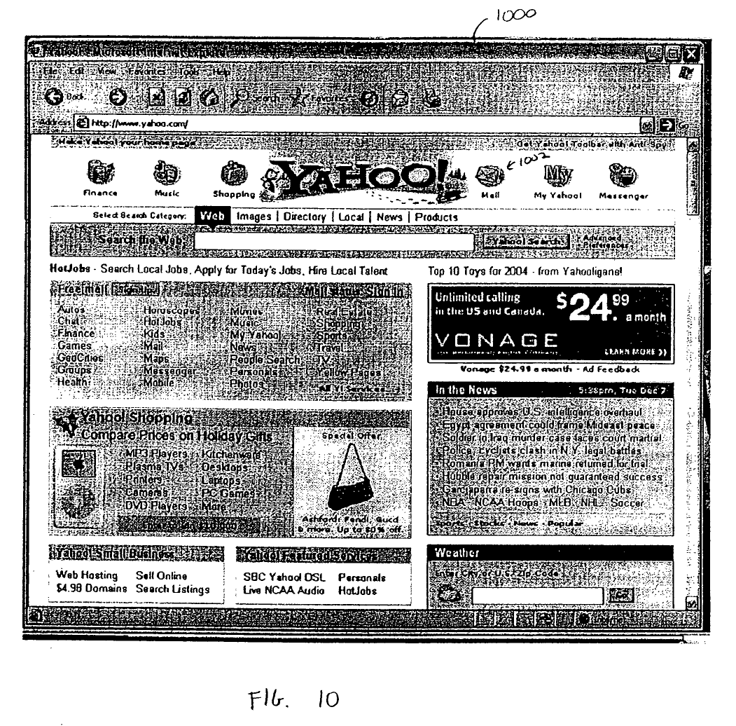

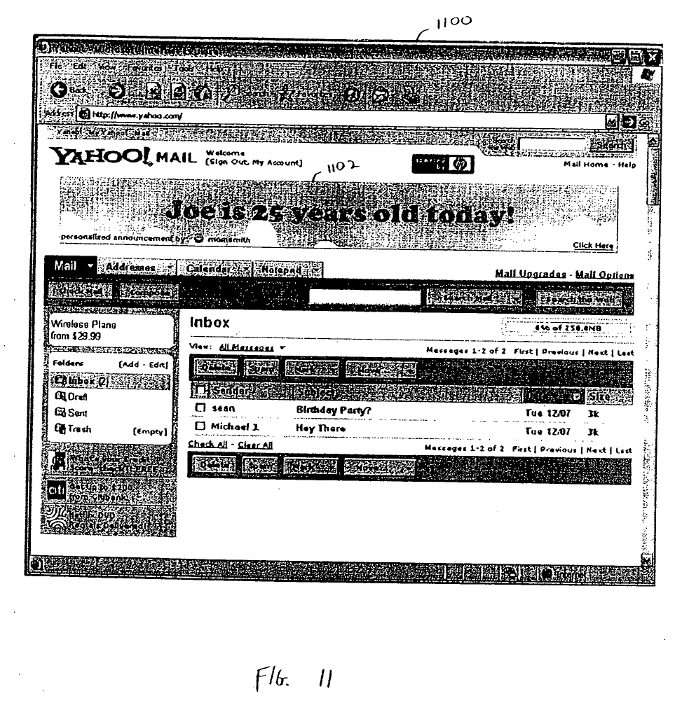

Referring to FIG. 10, recipients 160 may receive advertisements as part of their normal browsing of the Yahoo! web site 1000. As illustrated, recipients may receive personalized advertisements when accessing the Yahoo!'s email services, which may be accessed by selecting the appropriate control 1002. As shown in FIG. 11, the recipient may be redirected to a web page offering email services 1100, which may include an impression of the personalized advertisement 1102. As illustrated, the advertisement 1102 may include certain personalization information, such as name and age information. Optionally, advertiser 110 information may also be included in the advertisement.

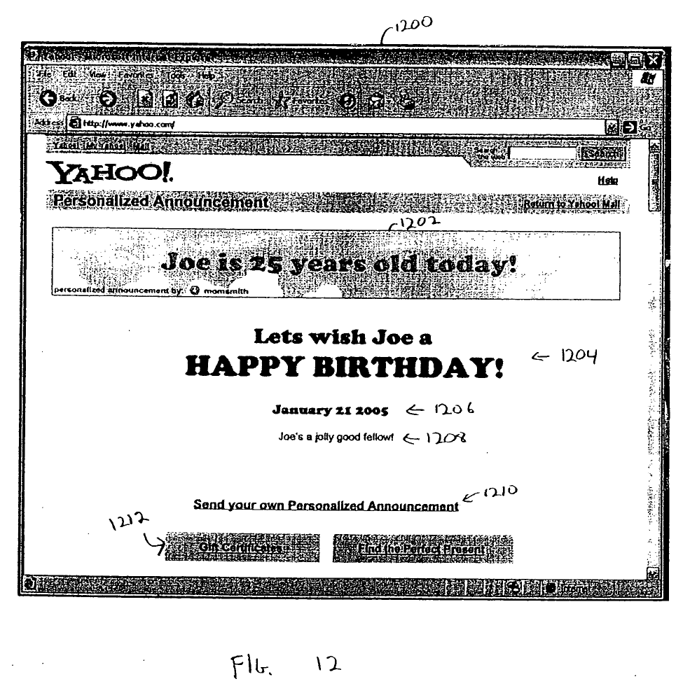

Recipients may click on the advertisement 1102 to be redirected to a landing page associated with the advertisement. An exemplary landing page 1200 is shown in FIG. 12. The landing page may include an additional impression of the advertisement 1202, which may or may not count against the total number of impressions specified by the user. The landing page may also include additional information related to the advertisement 1202. For example, the birthday advertisement landing page may include a birthday wish 1204, birthday date 1206 and a greeting 1208. Optionally, a link 1210 may be provided that allow recipients to create their own personalized advertisement. As illustrated, links 1212 to birthday related services are also provided. The links may redirect recipients 160 to gift certificate and gift selection services, for example.

The recipient may be emotionally aroused by receiving the personalized advertisement. For example, a birthday greeting delivered to a recipient on his or her birthday is likely to cause the recipient to feel appreciative and/or grateful. Similarly, a birthday greeting may remind a recipient to purchase a gift for the birthday of a relative, friend, and the like, and may cause the recipient to feel a sense of urgency to make the purchase. Such recipients may be highly responsive to targeted marketing materials, such as banner ads, emails, instant messages and the like, that may be delivered after delivering the personalized ad.

The targeted or directed ad may be delivered while the recipient is emotionally charged. For example, the targeted or directed marketing materials may be delivered in response to the delivery of the personalized greeting. The directed marketing materials may be sent with a determined time following delivery of the personalized greeting. Exemplary time periods may include immediately after delivery of the personalized ad, on the next page view by a recipient, at some point during the same browsing session, or any time until the event has passed. Other time restrictions may also be used, including no time restriction at all. Additionally, the targeted marketing materials may be based on the type of creative used or greeting sent. For example, if a birthday announcement was sent, targeted marketing materials relating to birthday gifts, party supplies, and the like may be delivered to the recipient. Also, fees may be charged for the targeted advertisements. For example, a $10 charge may be applied to the targeted delivery of advertisements after delivery of a personalized ad.

It is therefore intended that the foregoing detailed description be regarded as illustrative rather than limiting, and that it be understood that it is the following claims, including all equivalents, that are intended to define the spirit and scope of this invention.

1. A method for generating a personalized advertisement for a user, comprising:
providing a plurality of creatives;
receiving a first set of information indicative of at least one of the plurality of creatives;
receiving personalization information for customizing the at least one of the plurality of creatives;
generating a personalized advertisement including the first set of information and the personalization information;
receiving scheduling information for the personalized advertisement, the scheduling information including a plurality of specified recipients; and
submitting the personalized advertisement and the scheduling information to an advertisement tool.

2. The method of claim 1, wherein the plurality of creatives are banner ads.

3. The method of claim 1, wherein the plurality of creatives are related to events.

4. The method of claim 3, wherein the personalization information includes at least one selected from the group consisting of sender information, event information, and color information.

5. The method of claim 1, where the scheduling information includes a recipient identifier so that the advertising tool delivers the personalized advertisement to the specified recipients.

6. The method of claim 5, wherein the specified recipients associated with the identifier is in a permissive relationship with the user.

7. The method of claim 6, wherein the recipient is associated with a buddy list of the user.

8. The method of claim 1, further comprising:
calculating a cost for the personalized advertisement based in part on either the first set of information, the personalization information, the scheduling information, or any combination thereof.

9. The method of claim 1, further comprising:
causing targeted advertising to be delivered to at least one of the plurality of recipients of the personalized advertisement after delivery of the personalized advertisement, where the targeted advertising is delivered to the recipient based in part on the delivery of the personalized advertisement.

10. A system for delivering personalized advertisements to a plurality of recipients, the system comprising:
a web site including a plurality of web pages including advertisements;
an advertisement personalization module in communication with the web site and operable to
customize an advertising template in response to user input,
receive advertisement scheduling information and a plurality of specified recipients, each specified recipient being a registered user of the web site, and
submit the customized advertisement template, scheduling information, and specified recipients to an ad server;
where the web site delivers the customized advertisement template to the plurality of specified recipients as part of the web page advertisements in accordance with the scheduling information.

11. The system of claim 10 further comprising a cost calculation module in communication with the advertisement personalization module and operable to calculate a fee associated with the customized advertising template, the fee based on the scheduling information.

12. The system of claim 11, where the scheduling information includes a maximum number of impressions and the fee is based in part on the maximum number of impressions.

13. The system of claim 11, where the scheduling information includes a recipient list that includes the specified recipients and the fee is based in part on the recipient list.

14. The system of claim 11, where the fee is based in part on customized advertising template.

15. The method of claim 10, where the advertisement personalization module is further operable to customize a plurality of advertising templates and submit the customized plurality of advertising templates to the ad server, where the web site delivers the plurality of advertising templates to the plurality of specified recipients in accordance with the scheduling information.

16. The system of claim 15, where the web site delivers the plurality of advertising templates to each of the plurality of specified recipients in accordance with the scheduling information.

17. The system of claim 10, where the plurality of specified recipients are in a permissive advertising relationship an advertiser.

18. The system of claim 10, where the web site delivers targeted advertising to at least one of the plurality of specified recipients after delivering the customized advertising template, the targeted advertising being delivered to the recipient based in part on the delivery of the personalized advertisement.

19. A method for delivering a personalized greeting to a recipient, comprising:
providing a plurality of greeting templates, each greeting template comprising a banner;
receiving a first set of information indicative of a selection of at least one of the plurality of greeting templates;
receiving personalization information for customizing the selected greeting template;
generating a personalized greeting including the selected greeting template and the personalization information;
receiving scheduling information for the personalized greeting; and
delivering the personalized greeting to the recipient as an advertisement on a web page in accordance with the scheduling information.

20. The method of claim 19, further comprising:
causing targeted advertising to be delivered to the recipient after delivery of the personalized greeting.

21. The method of claim 20, where the targeted advertising is delivered to the recipient based in part on the delivery of the personalized greeting.

22. The method of claim 21, where the targeted advertising is delivered to the recipient during a single browsing session, the single browsing session also including the delivery of the personalized greeting.

23. The method of claim 21, where the targeted advertising is delivered to the recipient on a second web page, where the web page and the second web page are viewed by the recipient sequentially.
